(19) United States
(12) Patent Application Publication
(10) Pub. No.: US 2009/0059597 A1
(43) Pub. Date: Mar. 5, 2009

(54) Energy-saving lampshade with even light distribution

(76) Inventor: Ping-Han Chuang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,569

(22) Filed: Sep. 2, 2008

(30) Foreign Application Priority Data
Sep. 5, 2007 (TW) 096132995

(51) Int. Cl. F21V 7/00

(52) U.S. Cl. 362/296

(57) ABSTRACT

An energy-saving lampshade with even light distribution is disclosed to include a lampshade body disposed at the top side to hold a light source, a light-transmissive plate at the bottom side, a light condenser and a curved light reflector mounted inside the lampshade body, and a reflector cone mounted on the light-transmissive plate inside the lampshade right below the light source. When the light source is controlled to emit light, the light condenser condenses light from the light source onto the reflector cone, and the reflector cone and the light reflector reflects light rays, and therefore light rays are evenly distributed in the illumination without showing the normal distribution (Gaussian distribution) and avoiding dazzling.

### BACKGROUND OF THE INVENTION

1. Field of the Invention

The present invention relates to a lampshade for lamp and more particularly, to an energy-saving lampshade with expected light distribution, which is environmentally friendly and practical for home, factory and street applications and, which is designed subject to the principles of optical reflection, refraction and critical angles, lowering light loss, assuring even distribution of light in the illumination area and, avoiding dazzling.

2. Description of the Related Art

Regular lighting fixtures include two types, one for indoor application and the other for outdoor application. FIG. 1 illustrates a conventional indoor lighting fixture, which comprises a light source 102, and an open type opaque lampshade 101 provided at the top side of the light source 102. The open type opaque lampshade 101 has a reflective inner surface 103. To avoid dazzling the eyes, the surface of the light source is usually frosted. Regular outdoor lighting fixtures are usually equipped with a full-closed lampshade (see FIG. 1B) in which the bottom light transmissive cover 104 is frosted to avoid dazzle. However, conventional lighting fixtures, either with an open type lampshade or a full-closed type lampshade, have the common drawbacks of big brightness loss and local concentration of light right below the light source.

### SUMMARY OF THE INVENTION

The present invention has been accomplished under the circumstances in view. It is one object of the present invention to provide an energy-saving lampshade, which eliminates the problem of uneven distribution of light in which the light intensity at the center area within the illumination space right below the light source is greater than the border area. To eliminate this problem of uneven distribution of light, the invention provides a light condenser configured to show a parabolic curve or elliptic curve and mounted inside the lampshade for condensing the light from the light source onto a reflector cone right below the light source, and a curved light reflector with facets at different angles for reflecting reflected light from the reflector cone toward predetermined illumination block areas. Through multiple reflections, light is evenly distributed.

It is one object of the present invention to provide an energy-saving lampshade, which eliminates the problem of brightness loss of the prior art designs due to the use of a frosted light-transmissive cover. To eliminate this problem of brightness loss, the invention provides a light-transmissive plate for output of light. The light-transmissive plate comprises an optical grating on its one side for controlling passing of light through the light-transmissive plate in such a manner that the incident angles of the light rays that fall at the light-transmissive plate at certain angles are greater than the critical angles of the light-transmissive plate, achieving full reflection and avoiding dazzling without reducing the brightness. By means of avoiding brightness loss, the invention achieves a power saving effect.

### BRIEF DESCRIPTION OF THE DRAWINGS

FIG. 1A is a schematic drawing of an open type lampshade according to the prior art.

FIG. 1B is a schematic drawing of a full-closed lampshade according to the prior art.

FIG. 2 is a schematic sectional view of an energy-saving lampshade in accordance with a first embodiment of the present invention.

FIG. 3 is an enlarged view of a part of the curved light reflector of the energy-saving lampshade in accordance with the first embodiment of the present invention.

FIG. 4 is a plain view showing the light-transmissive plate of FIG. 2 made in the form of a circular optical grating plate.

FIG. 4A is a side view of FIG. 4.

FIG. 4B is an enlarged view of part B of FIG. 4A.

FIG. 5 4 is a plain view showing the light-transmissive plate of FIG. 2 made in the form of a rectangular optical grating plate.

FIG. 5A is a side view of FIG. 5.

FIG. 5B is an enlarged view of part B of FIG. 5A.

FIG. 6 is a schematic drawing of the present invention, showing emission of light of the energy-saving lampshade.

FIG. 7 is a schematic sectional view of an energy-saving lampshade in accordance with a second embodiment of the present invention.

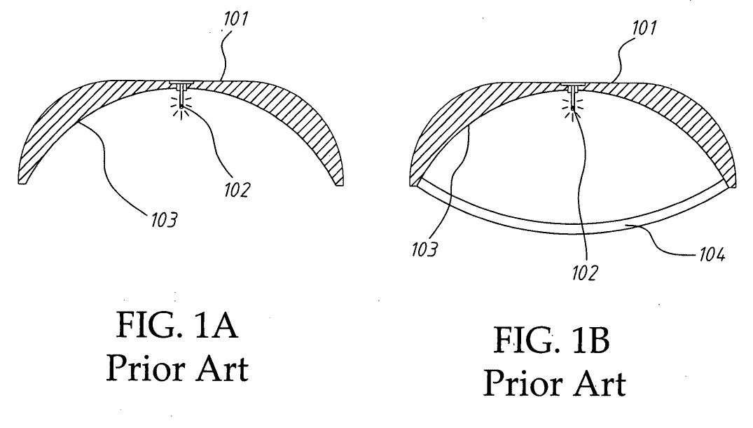

### DETAILED DESCRIPTION OF THE PREFERRED EMBODIMENT

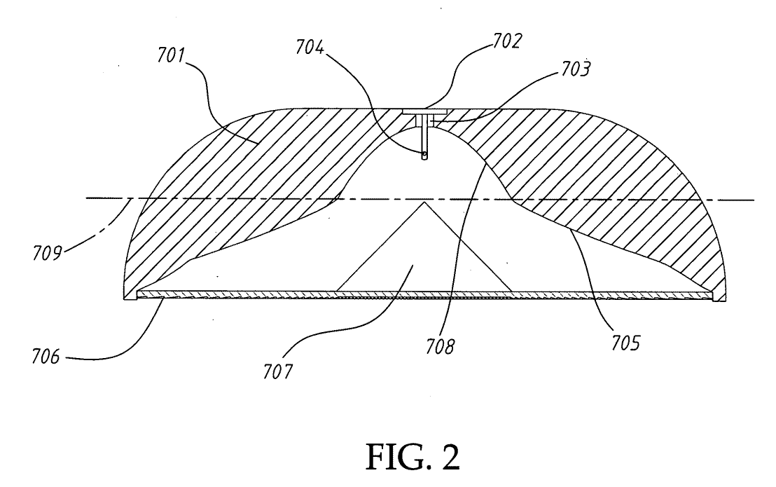

Referring to FIG. 2, a lampshade body 701 is shown having a top through hole 702 in which a lamp holder 703 is installed to hold a light emitting device 704 that emits light when electrically connected.

The lampshade body 701 has mounted therein a light condenser 708 and a curved light reflector 705. As shown in FIG. 2, the light condenser 708 that is disposed above the imaginary line 709 can be configured to show a parabolic curve or partially elliptic curve. According to this embodiment, the light condenser 708 is configured to show a parabolic curve. The light condenser 708 has a through hole for the passing of the light emitting device 704.

The curved light reflector 705 that is disposed below the imaginary line 709 is a fixedly mounted inside the lampshade body 701 and connected to the light condenser 708.

Further, a light-transmissive plate 706 is detachably covered on the bottom side of the lampshade body 701 within the illumination area. A reflector cone 707 is fixedly mounted on the inner side of the light-transmissive plate 706 within the lampshade body 701 in such a position that the vertex of the reflector cone 707 is aimed at the light emitting device 704 and, the light condenser 708 condenses the emitted light from the light emitting device 704 onto the reflector cone 707 for enabling the reflector cone 707 to reflect the condensed light onto the curved light reflector 705 that reflects the deflected light from the reflector cone 707 toward the illumination area to achieve the desired light distribution.

The curved light reflector 705 is formed of multiple facets, and the size of each facet of the curved light reflector 705 and the angle of each facet of the curved light reflector 705 relative to the horizontal line are calculated subject to the principle of optical reflection and expected contained angle between the incident light and the light reflected by each facet toward a specific illumination block.

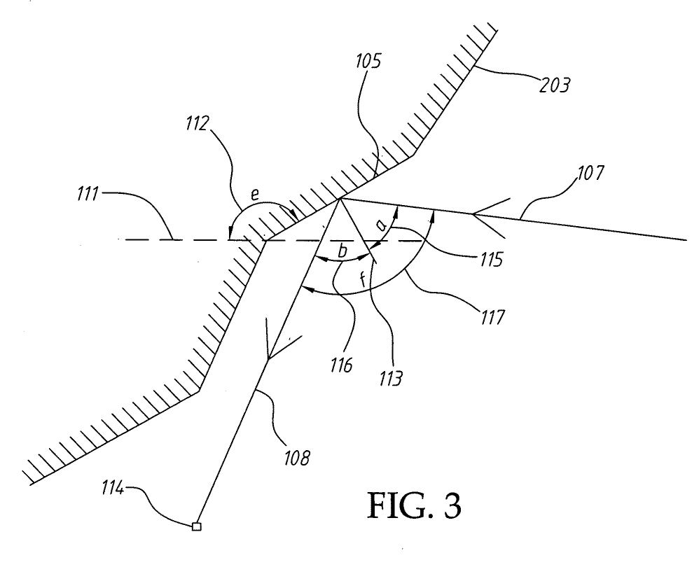

FIG. 3 is an enlarged view of part 203 of the curved light reflector 705. When an incident light 107 in a predetermined direction falls on one facet 105 and is being reflected by the facet 105 onto a specific illumination block 114, the incident light 107 and the reflected light 108 define a contained angle (f) 117. According to the principle of reflection, we can obtain that: contained angle f (117)÷2=incident angle a (115)=reflective angle b (116), and thus the accurate angle of the normal line 113 is obtained. Because the normal line 113 is perpendicular to the facet 105, the angle (e) 112 relative to the horizontal line 111 can thus be obtained.

The light-transmissive plate 706 comprises a plurality of critical angles, and at least one side of the light-transmissive plate 706 is provided with an optical grating. The open space, angle, specification and shape of the optical grating is determined subject to the optical critical angles of the material of the light-transmissive plate 706, such that the incident angle of the light rays emitted by the light emitting device 704 are greater than the critical angles, and the light rays emitted by the light emitting device 704 are fully reflected without passing through the light-transmissive plate 706 directly; the incident angles of the light rays that are not directly emitted by the light emitting device 704 are smaller than the critical angles. And the light rays that are not directly emitted by the light emitting device 704 directly go through the light-transmissive plate 706.

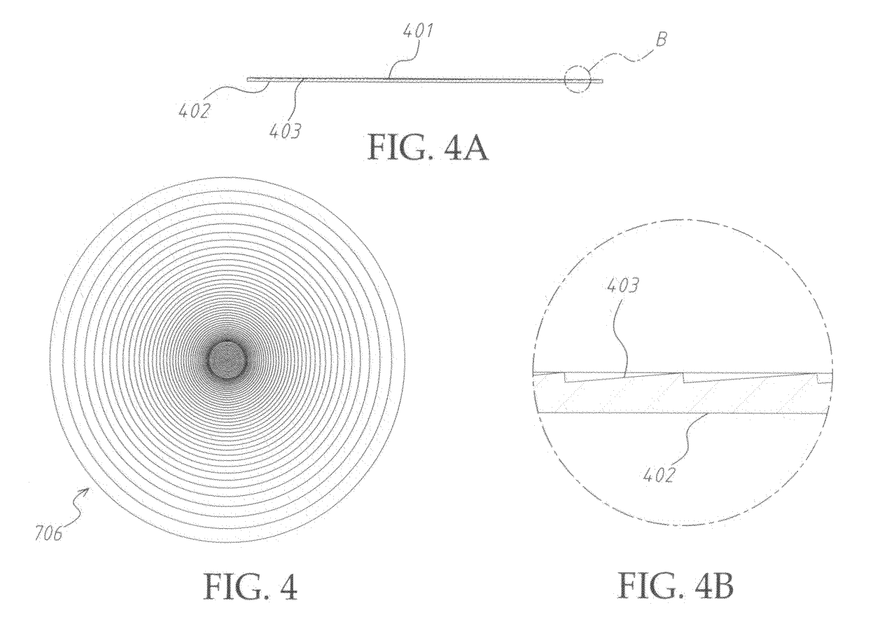

Referring to FIGS. 4 and 4A, the light-transmissive plate 706 shown in FIG. 2, can be a circular optical grating plate 401. As shown in FIG. 4B, the circular optical grating plate 401 has a grating of multiple annular lines 403 concentrically formed on its one side. The other side of the circular optical grating plate 401 can be a planar surface or provided with a grating of concentrically arranged annular lines. According to this embodiment, the other side of the circular optical grating plate 401 is a planar surface 402.

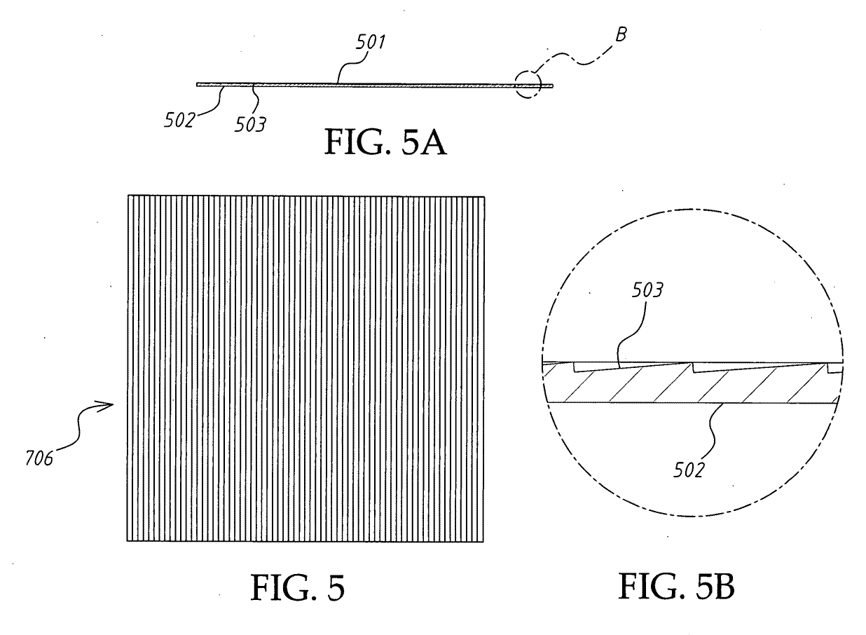

Referring to FIGS. 5 and 5A, the light-transmissive plate 706 shown in FIG. 2, can be a rectangular optical grating plate 501. As shown in FIG. 5B, the rectangular optical grating plate 501 has a grating of multiple straight lines 503 formed on its one side. The other side of the rectangular optical grating plate 501 can be a planar surface or provided with a grating of linear lines. According to this embodiment, the other side of the rectangular optical grating plate 501 is a planar surface 502.

FIGS. 4 and 5 show two different shapes of optical grating plates that have different grating spaces, grating angles and grating shapes for controlling every light ray that falls at the optical grating to pass through or to be reflected. For enabling a light ray to pass through, it is designed to have the incident angle of the light ray to be smaller than the corresponding critical angle of the light-transmissive plate. On the contrary, for enabling a light ray to be reflected, it is designed to have the incident angle of the light ray to be greater than the corresponding critical angle of the light-transmissive plate.

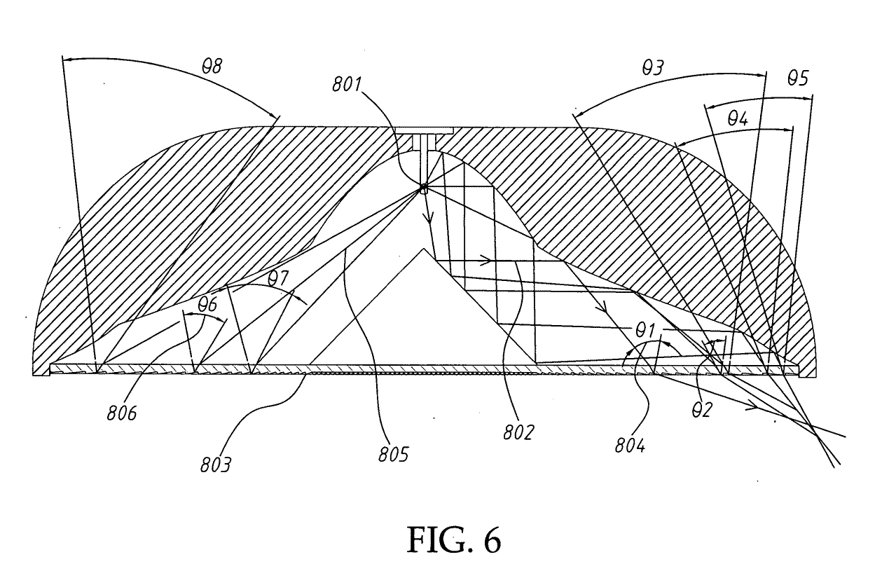

For example, as shown in FIG. 6, the critical angle of the acrylic light-transmissive plate, referenced by 803, is 42.15°. When one light ray 802 from the light source 801 fell at the surface of the acrylic light-transmissive plate 803 after through two reflections, it is refracted onto the optical grating at the other side of the acrylic light-transmissive plate 803 at 41.75° incident angle (θ1) 804. Because this 41.75° incident angle (θ1) 804 is smaller than the critical angle 42.15° of the acrylic light-transmissive plate 803, this light ray is refracted through the acrylic light-transmissive plate 803 again and then enters the illumination space. The incident angles θ2˜θ5 of the other light rays are 37.72°, 38.91°, 28.34° and 22.64° respectively that are smaller than the critical angle 42.15° of the acrylic light-transmissive plate 803, and therefore these light rays are refracted through the acrylic light-transmissive plate 803 again and then enter the illumination space.

Another light ray 805 from the light source 801 that fell at the surface of the acrylic light-transmissive plate 803 is refracted onto the optical grating at the other side of the acrylic light-transmissive plate 803 at 42.83 incident angle (θ6) 806. Because this 42.83 incident angle (θ6) 806 is greater than the critical angle 42.15° of the acrylic light-transmissive plate 803, this light ray is fully reflected without passing through the acrylic light-transmissive plate 803. The incident angles θ7 and θ8 of the other light rays are 43.46° and 42.72° respectively that are greater than the critical angle 42.15° of the acrylic light-transmissive plate 803, and therefore these light rays are fully reflected without passing through the acrylic light-transmissive plate 803.

From the explanation shown in FIG. 6, the light condenser 708 that is mounted inside the lampshade and configured to show a parabolic curve or partially elliptic curve condenses light rays onto the surface of the reflector cone 707; the curved light reflector 705 is formed of multiple facets of different sizes and angles effectively reflects light rays toward the predetermined illumination space, achieving an even distribution of light; the reflector cone 707 is arranged right below the light source to have a part of the light rays to be projected onto the expected illumination blocks through multiple reflections, assuring accurate radiation of light rays onto specific blocks.

Further, the light-transmissive plate 706 is a covering at the illumination side, having optical gratins arranged on one surface thereof at different angles for controlling passing of the light rays of which the incident angles are greater than the critical angle of the light-transmissive plate 706 so that all the light rays that pass through the light-transmissive plate 706 had been reflected at least once, avoiding dazzling and brightness loss, and achieving a power saving effect.

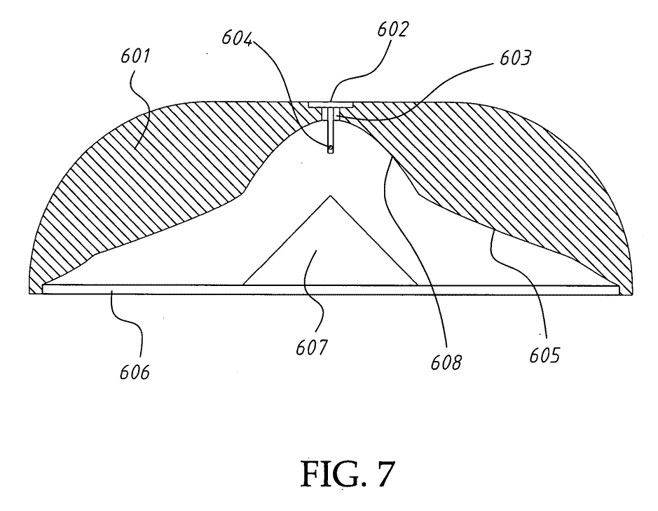

FIG. 7 is a schematic sectional view of an energy-saving lampshade in accordance with a second embodiment of the present invention. This second embodiment comprises a lampshade body 601, which has a top through hole 602 in which a lamp holder 603 is installed to hold a light emitting device 604 that emits light when electrically connected, a light condenser 608, which is configured to show a parabolic curve or partially elliptic curve and has a through hole for the passing of the light emitting device 604, a curved light reflector 605 fixedly mounted inside the lampshade body 601 and connected to the light condenser 608, a light-transmissive plate 606 detachably covered on the bottom side of the lampshade body 601, and a reflector cone 607 fixedly mounted on the inner side of the light-transmissive plate 606 with the vertex thereof aimed at the light emitting device 604.

The curved light reflector 605 and the light condenser 608 of this second embodiment are designed in the same way as that of the aforesaid first embodiment. The lampshade of this second embodiment achieves the same effect of providing even illumination, avoiding brightness loss for energy saving.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An energy-saving lampshade, comprising:
a lampshade body, said lampshade body having installed therein at least one lamp holder, said at least one lamp holder being electrically connected to power supply means;
at least one light emitting device installed in said at least one lamp holder for emitting light;
a light condenser, said light condenser comprising at least one through hole for the passing of said at least one light emitting device;
a light reflector fixedly mounted inside said lampshade body and connected to said light condenser, said light reflector comprising a curved surface formed of plurality of facets, the size of each said facet and the angle of each said facet relative to the horizontal line being calculated subject to the principle of optical reflection and expected contained angle between the incident light and the light reflected by each said facet toward a predetermined illumination block;
a light transmissive plate mounted in an illumination side of said lampshade body;
a reflector cone fixedly mounted on an inner side of said light-transmissive plate within said lampshade body, said reflector cone having a vertex aimed at said at least one light emitting device;
wherein said light condenser condenses the emitted light from said at least one light emitting device onto said reflector cone for enabling said reflector cone to reflect the condensed light onto said light reflector so that said light reflector reflects the deflected light from said reflector cone toward a predetermined illumination area to achieve an even distribution of light; said reflector cone causes a part of the light rays emitted by said at least one light emitting device to fall to a predetermined area through multiple reflections.

2. The energy-saving lampshade as claimed in claim 1, wherein said light-transmissive plate comprises a plurality of critical angles and an optical grating on at least one side thereof, the grating space, angle, specification and shape of said optical grating being determined subject to the principle of optical critical angle for controlling the light rays emitted by said at least one light emitting device onto said light-transmissive plate at an incident angle greater than said critical angles to be reflected and the light rays that fall at said light-transmissive plate at an incident angle smaller than said critical angles to pass through said light-transmissive plate.

3. The energy-saving lampshade as claimed in claim 2, wherein said light-transmissive plate is formed of a circular grating plate comprising a plurality of concentrically arranged annular lines.

4. The energy-saving lampshade as claimed in claim 2, wherein said light-transmissive plate is formed of a rectangular grating plate comprising a grating of straight lines.

5. The energy-saving lampshade as claimed in claim 2, wherein said light condenser is configured to show a parabolic curve.

6. The energy-saving lampshade as claimed in claim 2, wherein said light condenser is configured to show a partially elliptic curve.
